(19) United States
(12) Patent Application Publication
(10) Pub. No.: US 2025/0045488 A1
(43) Pub. Date: Feb. 6, 2025

(54) ADAPTIVE MULTI-LEVEL PHASE-FIELD METHOD FOR BRITTLE FRACTURE OF ELASTIC MATERIALS UNDER THERMAL SHOCK

(71) Applicant: DALIAN UNIVERSITY OF TECHNOLOGY, Dalian (CN)

(72) Inventors: Yonggang ZHENG, Dalian (CN); Weilong YANG, Dalian (CN); Weishuai LI, Dalian (CN); Yisong QIU, Dalian (CN); Hongfei YE, Dalian (CN)

(21) Appl. No.: 18/924,242

(22) Filed: Oct. 23, 2024

(30) Foreign Application Priority Data
Sep. 11, 2024 (CN) 202411270721.4

(51) Int. Cl. G06F 30/23

(52) U.S. Cl. CPC G06F 30/23

(57) ABSTRACT

The present invention belongs to the field of computational mechanics, and provides an adaptive multi-level phase-field method for brittle fracture of elastic materials under thermal shock, thus to provide a new numerical calculation method for efficient fracture study. In the present invention, damage degree of a material is characterized by a phase field, and the multi-level hp-FEM is used as an adaptive strategy to implement dynamic discretization in a process of crack propagation under thermal shock. Compared with previous adaptive phase-field fracture models, the present invention has no hanging nodes, and has simple numerical implementation and high calculation efficiency, which can effectively predict the fracture behavior of a structure. At the same time, three pre-existing crack treatment techniques are developed to initialize the phase field. The temperature, displacement and phase fields are solved by an alternating minimization algorithm, which can stably and effectively solve the multi-field coupling large-scale fracture problems.

### TECHNICAL FIELD

The present invention belongs to the field of computational mechanics, and relates to an adaptive phase-field method for brittle fracture of elastic materials under thermal shock.

### BACKGROUND

Thermal shock fracture exists widely in engineering practice and daily life, for example thermal cracking caused by rapid temperature changes in machining and manufacturing processes (such as additive manufacturing, quenching and welding), microcracks of a multiphase composite material produced during machining due to different thermal expansion coefficients, and self-explosion of window glass in hot weather. Therefore, the study of the failure mechanism under thermal shock is helpful to the safety assessment of a structural device. If an analysis is carried out by experimental means, it is difficult and expensive to implement the analysis, difficult to consider the influence of multiple external factors on a fracture behavior, and difficult to observe a crack evolution process. As a new high performance simulation computing technology, numerical simulation can help us to further explore the failure process under thermal shock, so as to predict the failure behavior of a material comprehensively and accurately. However, the study of multi-field coupling fracture simulation under thermal shock is still a very challenging topic, mainly because it requires comprehensive and detailed consideration of stable crack propagation simulation, multi-physical field coupling solution and effective integration of efficient adaptive methods.

For the numerical simulation of fracture, two types of methods are mainly used at present: discrete crack characterization methods and smeared crack characterization methods. Among which, the discrete crack characterization methods are to describe cracks by explicitly defining crack collection information, which include mesh type treatment methods such as the element deletion method, the cohesive zone model (CZM) method and the extended finite element method (XFEM). In a simulation process, a crack will propagate, and the geometry thereof will change with the load and time, so that a mesh needs to be redivided constantly in a solution process, which greatly consumes the computing resources. At the same time, due to the limitation of their own algorithm, the discrete crack characterization methods cannot treat complex fracture behaviors such as crack initiation, bifurcation and intersection easily and efficiently. Whereas the smeared crack characterization methods are to characterize cracks by field variables without the need of separate crack modeling or mesh redivision, which improves the computational efficiency and reduces the difficulty of numerical implementation to a certain extent, and has significant advantages in treating complex fractures.

In the smeared crack characterization methods, Bourdin et al. has developed a regularized approximate smeared fracture model, i.e. a phase field model, in “Numerical experiments in revisited brittle fracture” based on the fracture variational principle proposed by Francfort and Marigo. The model describes cracks by a phase field variable to characterize the damage value of a material, and has been widely used in treating crack initiation and propagation. Amor et al. has conducted volume-deviatoric strain decomposition of strain energy in “Regularized formulation of the variational brittle fracture with unilateral contact: Numerical experiments”, assuming that crack evolution can only be driven by a deviatoric stress and a positive spherical stress. In 2010, Miehe et al. has re-established a phase-field fracture model in “A phase field model for rate-independent crack propagation: Robust algorithmic implementation based on operator splits” under the framework of thermodynamics. Strain energy is decomposed into tensile and compressive parts by the strain tensor spectrum, and it is believed that crack evolution can only be driven by tensile deformation, so that unrealistic crack propagation during compression is prevented. In order to simulate a fracture process more accurately, Borden et al. has proposed a fourth-order phase-field fracture equation in “A phase-field description of dynamic brittle fracture” under the framework of the isogeometric analysis method to simulate the fracture of a brittle material. In order to treat the quasi-brittle fracture of a material more accurately, Professor Wu Jianying has introduced the concept of cohesive force into the phase-field fracture model and proposed the phase-field regularized cohesive zone model (PF-CZM), which is combined with the Broyden-Fletcher-Goldfarb-Shanno (BFGS) algorithm to further improve the computational efficiency. When the phase field model is used for simulating crack evolution, it is not necessary to update the geometric topology of the model. The phase field model has advantages in treating complex fracture modes such as crack initiation, propagation and intersection, and is widely used in various types of fractures, such as thermal cracking, dynamic fracture, hyperelastic fracture, hydraulic fracture and shock fracture. Among which, the study on thermal cracking is helpful to the safety assessment of manufacturing processes such as additive manufacturing, quenching and casting, and has drawn the attention of numerous scholars. Tangella et al. has adopted the hybrid phase-field method in “Hybrid phase-field modeling of thermo-elastic crack propagation” to simulate the fracture of an elastic-brittle material. Ruan et al. has proposed a thermo-mechanical phase-field fracture model in “A thermo-mechanical phase-field fracture model: Application to hot cracking simulations in additive manufacturing”, discussed the influence of temperature on the fracture mode, and applied the model to the simulation of small crack initiation in additive manufacturing. Mandal et al. has used PF-CZM to simulate the thermal cracking phenomenon of elastic-brittle material in “Fracture of thermo-elastic solids: Phase-field modeling and new results with an efficient monolithic solver”, and further improved the computational efficiency by the BFGS algorithm.

The phase field model has been widely used in the simulation of the fracture process, but the numerical simulation requires extremely fine mesh, which makes the calculation amount large. In order to meet the mesh requirements without significantly increasing the computational cost, an adaptive mesh refinement scheme is widely used in phase-field fracture simulation. Heister et al. has proposed a predictor-corrector mesh adaptivity method with h-refinement in “A primal-dual active set method and predictor-corrector mesh adaptivity for computing fracture propagation using a phase-field approach” to locally refine the mesh in real time during crack propagation. Patil et al. has proposed a phase-field fracture model under an adaptive multiscale finite element method (MsFEM), which can significantly reduce the computational cost and improve the computational efficiency. Recently, Zander et al. has proposed a new adaptive method in “Multi-level hp-adaptivity: high-order mesh adaptivity without the difficulties of constraining hanging nodes”, which is called the multi-level hp-FEM. The method uses superimposed fine meshes to realize local refinement. In most of the adaptive methods in the past, fine meshes are used instead of coarse meshes, which will cause hanging node problems and lead to complex numerical implementation. Whereas the multi-level hp-FEM uses the idea of refinement and the high-order integrated Legendre polynomial for shape function, so that the multi-level hp-FEM has no hanging nodes, and the numerical implementation is easier. At the same time, the advantages of h-refinement and p-refinement are fully utilized to allow high convergence in the process of treating the problem of high gradients. The characteristics are suitable for phase-field fracture simulation, and the cracks are locally covered by multi-level fine meshes, thus to reduce the consumption of the computing resources.

In the present invention, the multi-level hp-FEM is used as an adaptive strategy to conduct dynamic discretization of the thermo-mechanical phase-field fracture model, and three pre-existing crack treatment techniques are developed to ensure the accurate imposition of crack boundaries in the phase field. Moreover, the alternating minimization algorithm is adopted to effectively obtain temperature, displacement and phase fields. The study of an efficient numerical method for fracture analysis of an elastic-brittle material under thermal shock proposed by the present invention can capture the crack evolution process efficiently, has no hanging nodes in traditional adaptive methods, has easy numerical implementation, is used for simulating the elastic-brittle fracture mechanical behavior of a structure under a thermal shock load, and provides an effective way for the accurate analysis of engineering fractures.

### SUMMARY

Aiming at the efficient numerical analysis of fracture of an elastic-brittle material under thermal shock, the present invention innovatively proposes an adaptive multi-level phase-field method (AMLPFM). The purposes are that: first, in order to overcome the deficiency of traditional damage model which is difficult to accurately capture a crack propagation path and explore the fracture behavior under thermal shock, the present invention deduces a phase-field fracture model aiming at the thermo-mechanical fracture behavior of an elastic-brittle material based on the energy functional variational principle, and uses the alternating minimization algorithm to solve the coupled governing equations. Second, aiming at the fine mesh requirements of a fracture phase field and the problem of hanging nodes in the traditional adaptive strategy, the present invention proposes a novel adaptive multi-level discrete scheme, which can be more easily implemented numerically. In a simulation process, based on the advance of a phase field contour, a crack tip is tracked to identify a refinement region, and a mesh is dynamically updated in real time to reduce the calculation cost and improve the calculation efficiency. In addition, the present invention provides three pre-existing crack treatment techniques (dividing the geometric model, applying the damage Dirichlet boundary condition weakly and weakening the material properties surrounding the pre-existing cracks) to accurately consider the influence of various pre-existing cracks under the multi-level framework. Finally, the present invention aims to solve the shortcomings of the existing finite element-phase field method that the calculation cost is high due to a fine mesh in analyzing the fracture problem under thermal shock, and the limitation of complex numerical implementation due to the problem of hanging nodes in the previous adaptive methods.

The technical solution of the present invention is as follows:

An adaptive multi-level phase-field method for brittle fracture of elastic materials under thermal shock, and an adaptive multi-level phase-field method (AMLPFM) for thermal cracking simulation. In order to accurately capture the high gradients of a thermal stress during thermal shock and reduce the calculation cost in fracture simulation analysis, the present invention combines the multi-level hp-method with a thermo-mechanical phase-field fracture model to predict the initiation and propagation of a crack under a thermo-mechanical-displacement load, and provides an adaptive multi-level phase-field method. The specific steps are as follows:

Considering an arbitrary thermo-mechanical solid domain (computational domain) Ω, containing a sharp crack Γ in time t∈[0, tₐ], as shown in FIG. 1. Combining with the existing thermo-mechanical phase-field fracture model, the following governing equations can be obtained,

$$\begin{matrix}∇ \cdot σ + b = 0 , & in Ω \times [ 0 , {t}_{a} ] ,\end{matrix} \qquad ( 1 )$$

$$\begin{matrix}ρcθ + ∇ \cdot J = γ , & in Ω \times [ 0 , {t}_{a} ] ,\end{matrix} \qquad ( 2 )$$

$$\begin{matrix}- 2 ( 1 - d ) {ψ}_{e}^{+} + \frac{{G}_{c}}{{l}_{0}} ( d - {l}_{0}^{2} Δ d ) = 0 , & in Ω \times [ 0 , {t}_{a} ] ,\end{matrix} \qquad ( 3 )$$

$$\begin{matrix}σ \cdot n = \overline{t} , & in \partial {Ω}_{t} \times [ 0 , {t}_{a} ] ,\end{matrix} \qquad ( 4 )$$

$$\begin{matrix}J \cdot n = \overline{q} , & in \partial {Ω}_{q} \times [ 0 , {t}_{a} ] ,\end{matrix} \qquad ( 5 )$$

$$\begin{matrix}∇ d \cdot n = 0 , & in \partial Ω \times [ 0 , {t}_{a} ] ,\end{matrix} \qquad ( 6 )$$

Wherein equations (1), (2) and (3) are the governing equations of a displacement field u=Ω×[0, tₐ], a temperature field θ=Ω×[0, tₐ] and a phase field d=Ω×[0, tₐ]→[0,1], respectively, and equations (4)-(6) are the corresponding boundary conditions; σ is the Cauchy stress and is the strain energy density of a tensile part, ρ is the density, c is the specific heat capacity, \dot{θ} is the rate at which temperature changes over time, γ is the internal thermal source, G_{c} is the critical energy release rate, l₀ is the crack width used for controlling the width of a smeared crack band, b is the physical strength, J is the heat flux, and n is the outward normal vector of the solid domain boundary ∂Ω; displacement, traction, temperature and heat flux boundary conditions are ∂Ωᵤ, ∂Ωₜ, ∂Ω_{θ} and ∂Ω_{q}, respectively, and displacement ū, traction t̅, temperature θ̅ and heat flux q̅ are applied accordingly.

Considering the strain spectrum decomposition format given by Miehe et al., decomposing the strain energy density ψₑ into the tensile part ψₑ⁺ and a compressive part ψₑ⁻, and weakening the tensile part, that is,

$${ψ}_{e} ( {ε}_{e} ( u , θ ) ) = w ( d ) {ψ}_{e}^{+} + {ψ}_{e}^{-} , \qquad ( 7 )$$

Wherein εₑ is the elastic strain, w(d)=(1−d)²+ξ is the degradation function, 0<ξ<<1 is added to obtain a better numerical stability.

Then the Cauchy stress σ can be derived as follows,

$$σ = w ( d ) \frac{\partial {ψ}_{e}^{+}}{\partial {ε}_{e}} + \frac{\partial {ψ}_{e}^{-}}{\partial {ε}_{e}} \qquad ( 8 )$$

The relationship between the elastic strain εₑ and the thermal strain ε_{θ} under the thermo-mechanical framework is as follows,

$${ε}_{e} = ε - {ε}_{θ} , \qquad ( 9 )$$

Wherein the total strain under the assumption of small strain is

$$ε = \frac{1}{2} ( ∇ u + {∇}^{T} u ) ,$$

ε_{θ}=α(θ−θ₀)I is the expression of the thermal strain, α is the thermal expansion coefficient, θ₀ is the initial temperature, and I is the identity tensor.

In order to satisfy the irreversibility of crack growth, a historical maximum strain energy H is introduced to replace ψₑ⁺ in formula (3),

$$H = {max}_{τ ∈ [ 0 , t ]} \{ {ψ}_{e}^{+} ( {ε}_{e} , τ ) \} \qquad ( 10 )$$

Thus to prevent non-physical crack healing due to the drop of ψₑ⁺.

According to Fourier's law, the heat flux J is,

$$J = - {k}_{d} \cdot ∇ θ , \qquad ( 11 )$$

Wherein, in order to ensure no heat flux across the crack surface, the inherent thermal conductivity k_{d} is also degraded by the phase field value d, that is,

$${k}_{d} = w ( d ) {k}_{0} , \qquad ( 12 )$$

k₀ is the inherent thermal conductivity for undamaged material; when d=0, the heat transfer capacity of material is not affected, and when d=1, the material no longer has heat transfer capacity.

The above is a thermo-mechanical phase-field fracture model; when a mesh type method is used to solve the problem, the crack need to be divided into very fine meshes, and the calculation cost is high, so it is necessary to combine an adaptive refinement method. In the present invention, a novel adaptive strategy (the multi-level hp-FEM) is adopted, the fine mesh is refined in real time with crack propagation in the simulation process, no hanging node exists, and the numerical implementation is simple, so that the fracture behavior under thermal shock can be efficiently and effectively simulated and analyzed.

Different from the previous adaptive methods, the idea of superposition is adopted to realize adaptive refinement in the present invention, the computational domain Ω is discretized into a base mesh by a coarse mesh, and is locally discretized into a multi-level fine mesh (which is called an overlay mesh) at a crack path, as shown in FIG. 2. According to the idea of superposition, the approximate physical value at arbitrary x₀ can be expressed as follows,

$$u = {u}_{b} + {u}_{o 2} + ⋯ + {u}_{{on}_{k}} \qquad ( 13 )$$

Wherein the subscripts b and o represent the base mesh and the overlay mesh, respectively, and u_{b}, uₒ₂ and uₒₙ_{ₖ} represent the approximate physical values on the base mesh and the overlay mesh, respectively; when such refinement strategy is used, the linear independence and compatibility of shape functions have to be considered, so as to eliminate the problem of hanging nodes in the previous adaptive methods.

In the present invention, the adaptive refinement strategy with the idea of superposition is introduced into the governing equations (1)-(6) of the thermo-mechanical phase-field fracture model, and the global computational domain Ω is discretized into the base mesh Ω_{b} and the multi-level overlay mesh Ωₒₙ, wherein n=2, . . . , nₖ. The temperature field θ, the displacement field u, the phase field d and spatial derivatives thereof are expressed as follows,

$$θ = {θ}_{b} + {\sum }_{n = 2}^{{n}_{k}} {θ}_{on} , u = {u}_{b} + {\sum }_{n = 2}^{{n}_{k}} {u}_{on} , d = {d}_{b} + {\sum }_{n = 2}^{{n}_{k}} {d}_{on} , \qquad ( 14 )$$

$$∇ θ = ∇ {θ}_{b} + {\sum }_{n = 2}^{{n}_{k}} ∇ {θ}_{on} , ε = {ε}_{b} + {\sum }_{n = 2}^{{n}_{k}} {ε}_{on} , ∇ d = ∇ {d}_{b} + {\sum }_{n = 2}^{{n}_{k}} ∇ {d}_{on} , \qquad ( 15 )$$

The temperature approximate values Bb and Bon in each level of mesh after discretization can be interpolated as follows,

$$\{ \begin{matrix}{θ}_{b} = {N}_{b}^{N} ( {η}_{b} ) {θ}_{b}^{N} + {N}_{b}^{E} ( {η}_{b} ) {θ}_{b}^{E} + {N}_{b}^{F} ( {η}_{b} ) {θ}_{b}^{F} \\ {θ}_{on} = {N}_{on}^{N} ( {η}_{on} ) {θ}_{on}^{N} + {N}_{on}^{E} ( {η}_{on} ) {θ}_{on}^{E} + {N}_{on}^{F} ( {η}_{on} ) {θ}_{on}^{F}\end{matrix} \qquad ( 16 )$$

Wherein η. is the local coordinates under each level of mesh, N.^{N}, N.^{E} and N.^{F} are the shape functions attached to points, lines and surfaces, and the corresponding temperature values to be obtained on the shape functions are θ.^{N}, θ.^{E} and θ.^{F}. A consistent interpolation format can be used for the displacement values u_{b} and uₒₙ and the phase field values d_{b} and dₒₙ.

Considering arbitrary virtual variables δθ_{b}, δu_{b}, δd_{b}, δθₒₙ, δuₒₙ and δdₒₙ, the following weak forms can be obtained from the governing equations (1)-(6),

$$\{ \begin{matrix}{\int }_{Ω} [ ( ρc \dot{θ} {δθ}_{b} - J \cdot ∇ {δθ}_{b} ) + {\sum }_{n = 2}^{{n}_{k}} ( ρc \dot{θ} {δθ}_{on} - J \cdot ∇ {δθ}_{on} ) ] dV = δ {F}^{θ} , \\ {\int }_{Ω} ( σ : ∇ δ {u}_{b} + {\sum }_{n = 2}^{{n}_{k}} σ : ∇ δ {u}_{on} ) dV = δ {F}^{u} , \\ {\int }_{Ω} [ - 2 ( 1 - d ) H δ {d}_{b} + \frac{{G}_{c}}{{l}_{0}} ( {l}_{0}^{2} ∇ d \cdot ∇ δ {d}_{b} ) + d δ {d}_{b} ] dV + \\ {\sum }_{n = 2}^{{n}_{k}} {\int }_{Ω} [ - 2 ( 1 - d ) H δ {d}_{on} + \frac{{G}_{c}}{{l}_{0}} ( {l}_{0}^{2} ∇ d \cdot ∇ δ {d}_{on} ) + d δ {d}_{on} ] dV = 0 ,\end{matrix} \qquad ( 17 )$$

Wherein the virtual forces of the temperature field and the displacement field are as follows,

$$δ {F}^{θ} = {\int }_{Ω} ( {γδθ}_{b} + {\sum }_{n = 2}^{{n}_{k}} {γδθ}_{on} ) dV + {\int }_{\partial Ω} ( \overline{q} \cdot {δθ}_{b} + {\sum }_{n = 2}^{{n}_{k}} \overline{q} \cdot {δθ}_{on} ) dS , \qquad ( 18 )$$

$$δ {F}^{θ} = {\int }_{Ω} ( f \cdot δ {u}_{b} + {\sum }_{n = 2}^{{n}_{k}} f \cdot δ {u}_{on} ) dV + {\int }_{\partial Ω} ( \overline{t} \cdot δ {u}_{b} + {\sum }_{n = 2}^{{n}_{k}} \overline{t} \cdot δ {u}_{on} ) dS . \qquad ( 19 )$$

The basic format of coupled temperature-displacement-phase field in a multi-level hp mesh is derived based on the above theory and is loaded slowly in a quasi-static state, and then the Newton-Raphson alternating solution strategy is used to simulate crack initiation and propagation, so that the study of the adaptive multi-level phase-field method for brittle fracture of elastic materials under thermal shock proposed by the present invention can be realized.

The present invention is realized by MATLAB software programming, and the visualization of the results is realized by ParaView software. In combination with the schematic diagram of AMLPFM as shown in FIG. 3, the specific implementation steps are as follows:
Step 1: establishing a multi-level discrete mesh model and a finite element interpolation format, defining material parameters, considering linear independence and compatibility of shape functions, and judging the activation states of topological components (points, lines and surfaces) in each level of mesh;
Step 2: initializing the phase field values by dividing the geometric model, applying the phase-field Dirichlet boundary condition weakly or weakening the material properties surrounding the pre-existing cracks according to the position of the pre-existing cracks;
Step 3: using the Newton-Raphson iteration method to implement the alternating solution strategy in the current time step, updating the temperature, displacement and phase fields successively, and obtaining the temperature value, the displacement value and the phase field value in the current time step when iteration converges;
Step 4: storing and outputting the information of relevant variables, returning to step 3, and proceeding to a next time step until the calculation is completed.

In step 1, quadrilateral elements are used for discretization and refined into multi-level meshes on the tips or paths of the pre-existing cracks, as shown in FIG. 4. For simplicity, the symbol m is used to represent the base mesh b and the overlay mesh o. Then the temperature field θₘ, the displacement field uₘ and the phase field dₘ of each level of mesh after discretization can be expressed as follows,

$$\{ \begin{matrix}{θ}_{m} = {\sum }_{A} {N}_{m A}^{θ} ( x ) {θ}_{m A} = {N}_{m}^{θ} {a}_{m} , \\ {u}_{m} = {\sum }_{A} {N}_{m A}^{u} ( x ) {u}_{m A} = {N}_{m}^{u} {\hat{a}}_{m} , \\ {d}_{m} = {\sum }_{A} {N}_{m A}^{d} ( x ) {d}_{m A} = {N}_{m}^{d} {\overline{a}}_{m} ,\end{matrix} \qquad ( 20 )$$

Wherein N_{mA}^{θ}(x), N_{mA}^{u}(x) and N_{mA}^{d}(x) are the shape functions of the temperature, displacement and phase fields of the corresponding topological components; Nₘ^{θ}, Nₘ^{u} and Nₘ^{d} are the shape function matrices of the three fields, respectively, and the temperature value θ_{mA}, the displacement value u_{mA} and the phase field value d_{mA} attached to the topological components are assembled as vectors aₘ, âₘ and āₘ, respectively.

Then the spatial derivatives of the three fields can be further expressed as follows,

$$\{ \begin{matrix}∇ {θ}_{m} = {\sum }_{A} {B}_{m A}^{θ} ( x ) {θ}_{m A} = {B}_{m}^{θ} {a}_{m} , \\ {ε}_{m} = {\sum }_{A} {B}_{m A}^{u} ( x ) {u}_{m A} = {B}_{m}^{u} {â}_{m} , \\ ∇ {d}_{m} = {\sum }_{A} {B}_{m A}^{d} ( x ) {d}_{m A} = {B}_{m}^{d} {\overline{a}}_{m} ,\end{matrix} \qquad ( 21 )$$

Wherein B_{mA}^{θ}, B_{mA}^{u} and B_{mA}^{d} are

$$( 22 )$$

$${B}_{m A}^{θ} ( x ) = [ \begin{matrix}{\partial }_{x} {N}_{m A}^{θ} \\ {\partial }_{y} {N}_{m A}^{θ}\end{matrix} ] , {B}_{m A}^{u} ( x ) = [ \begin{matrix}{\partial }_{x} {N}_{m A}^{u} & 0 \\ 0 & {\partial }_{y} {N}_{m A}^{u} \\ {\partial }_{y} {N}_{m A}^{u} & {\partial }_{x} {N}_{m A}^{u}\end{matrix} ] , {B}_{m A}^{d} ( x ) = [ \begin{matrix}{\partial }_{x} {N}_{m A}^{d} \\ {\partial }_{y} {N}_{m A}^{d}\end{matrix} ] .$$

Wherein ∂ₓ and ∂_{y} represent the derivatives with respect to the x and y axes, respectively.

Considering the above discretization treatment and combining with the weak form (17) to obtain the residual equations of the three fields as follows, respectively,

$$\{ \begin{matrix}{( {δθ}_{b} )}^{T} \cdot {r}_{b}^{θ} + {( {δθ}_{o} )}^{T} \cdot {r}_{o}^{θ} = 0 , \\ {( δ {u}_{b} )}^{T} \cdot {r}_{b}^{u} + {( δ {u}_{o} )}^{T} \cdot {r}_{o}^{u} = 0 , \\ {( δ {d}_{b} )}^{T} \cdot {r}_{b}^{d} + {( δ {d}_{o} )}^{T} \cdot {r}_{o}^{d} = 0 ,\end{matrix} \qquad ( 23 )$$

Wherein r_{b}^{θ}, rₒ⁰, r_{b}^{u}, rₒ^{u}, r_{b}^{d} and rₒ^{d} are the residuals of the temperature, displacement and phase fields in each level of mesh, and b and o are used as subscripts to replace m, then the expressions of the temperature field residual rₘ^{θ}, the displacement field residual rₘ^{u} and phase field residual rₘ^{d} in each level of mesh are as follows,

$${r}_{m}^{θ} = {( {f}_{m}^{θ} )}_{ext} - {\int }_{{Ω}_{m}} {( {B}_{m}^{θ} )}^{T} {k}_{d} ∇ θ dV - {\int }_{{Ω}_{m}} ρ c {( {N}_{m}^{θ} )}^{T} \dot{θ} dV , \qquad ( 24 )$$

$${r}_{m}^{u} = {( {f}_{m}^{u} )}_{ext} - {\int }_{{Ω}_{m}} {( {B}_{m}^{u} )}^{T} σ dV , \qquad ( 25 )$$

$${r}_{m}^{d} = - [ {\int }_{{Ω}_{m}} \frac{{G}_{c}}{{l}_{0}} {( {N}_{m}^{d} )}^{T} d dV + {\int }_{{Ω}_{m}} {G}_{c} {{l}_{0} ( {B}_{m}^{d} )}^{T} ∇ d dV + {\int }_{{Ω}_{m}} {w}^{′} ( d ) {( {N}_{m}^{d} )}^{T} H dV ] . \qquad ( 26 )$$

At the same time, the external force (fₘ^{θ})ₑₓₜ of the temperature field and the external force (fₘ^{u})ₑₓₜ of the displacement field are as follows,

$${( {f}_{m}^{θ} )}_{e x t} = {\int }_{{Ω}_{m}} {( {N}_{m}^{θ} )}^{T} γ dV + {\int }_{\partial {Ω}_{q}} {( {N}_{m}^{θ} )}^{T} \overline{q} dS , \qquad ( 27 )$$

$${( {f}_{m}^{u} )}_{e x t} = {\int }_{{Ω}_{m}} {ρ ( {N}_{m}^{u} )}^{T} b dV + {\int }_{\partial {Ω}_{t}} {( {N}_{m}^{u} )}^{T} \overline{t} dS . \qquad ( 28 )$$

Under the framework of multi-level hp-FEM, the linear independence and compatibility of the shape functions need to be ensured. The linear independence is the requirement that the shape functions of a coarse scale mesh cannot be linearly combined by the shape functions of a fine scale mesh, and the compatibility is the requirement that the approximate solution after superposition has C⁰-continuity, which can be realized simply by deactivating (i.e. removing) the corresponding mesh topology components.

In step 2, the present invention selects a suitable method to initialize the phase field according to the position of the pre-existing cracks, as shown in FIG. 4. Two types of pre-existing cracks are found, wherein cracks 1 coincide with the edge of an element in each level of mesh, and cracks 2 pass diagonally through the inside of the element. The influence of pre-existing cracks will be considered by three methods below:

Method I: dividing the geometric model; the pre-existing cracks 1 are only refined locally in a crack tip region, and the mesh along the crack path is not treated, thus the pre-existing cracks 1 can be treated simply by dividing the geometric model; it should be noted that method I is only suitable for the first type of pre-existing cracks;

Method II: applying the phase-field Dirichlet boundary condition; the influence of arbitrary cracks can be considered by ensuring the phase field value d=1 at the pre-existing cracks in the simulated process; however, for the cracks 2 passing diagonally through the inside of the element, the Dirichlet boundary condition cannot be applied directly to the corresponding topological components to constrain the phase field value in the element; here, the penalty method is used to apply the phase-field Dirichlet boundary condition weakly to the inside of the element, and the steps are as follows:

First, selecting a number of nodes along the pre-existing cracks and letting the phase field value d=1 at the nodes, then the corresponding constraints are as follows,

$$[ \begin{matrix}{G}_{b b} & {G}_{b o} \\ {G}_{o b} & {G}_{o o}\end{matrix} ] \{ \begin{matrix}{\overline{a}}_{o} \\ {\overline{a}}_{o}\end{matrix} \} = V \to G \overline{a} = V , \qquad ( 29 )$$

Wherein G is the shape function matrix of the selected nodes in the base mesh and the overlay mesh, and V is a vector filled by element 1;

Then considering the above constraint equations in a pure phase field diffusion model; the initial phase field distribution can be obtained, and the solution format is as follows,

$$( {K}^{d} + α {G}^{T} G ) \overline{a} = α {G}^{T} V , \qquad ( 30 )$$

Wherein α=1×10⁵ is the penalty factor, and K^{d} is the total stiffness matrix for phase field;

Finally, using the Newton-Raphson iteration method make V=0 in the subsequent time steps to ensure that the phase field value on the pre-existing cracks alway maintains that d=1;

Method III: weakening the material properties surrounding the pre-existing cracks; for the pre-existing cracks 2, the effect approximate to that of method I can be achieved by weakening the material properties surrounding the pre-existing cracks, which is equivalent to making the material near the crack band particularly soft; here, a minimal scalar β is introduced to weaken the elasticity matrix of the crack band, that is,

$${D}^{*} = β D , \qquad ( 31 )$$

### Wherein 0<<β<1;

Both method II and method III can be used for treating various types of pre-existing cracks; in a solution process, method II is to introduce a penalty term to the solution format, while method III does not require additional operations.

In step 3, the present invention uses the Newton-Raphson iteration method to implement the alternating solution strategy in the current time step [tₗ, tₗ₊₁], and updates the temperature, displacement and phase fields successively; wherein \dot{θ} in the residual equation (24) of the temperature field is express as follows by the backward difference method,

$$\dot{θ} = \frac{{θ}_{l + 1} - {θ}_{l}}{Δ t} , \qquad ( 32 )$$

Wherein Δt=tₗ₊₁−tₗ is the time increment; the coupled nonlinear equations (24)-(26) are solved by the Newton-Raphson iteration method, wherein the solution format of the i^{th} iteration step is as follows:

First, fixing the displacement field â⁽ⁱ⁻¹⁾ and the phase field ā⁽ⁱ⁻¹⁾ of the previous iteration step, and solving the temperature field a⁽ⁱ⁾ of the current iteration step according to equation (24),

$$\{ \begin{matrix}{a}_{b}^{( i )} \\ {a}_{o}^{( i )}\end{matrix} \} = \{ \begin{matrix}{a}_{b}^{( i - 1 )} \\ {a}_{o}^{( i - 1 )}\end{matrix} \} + {[ \begin{matrix}{K}_{b b}^{θ} & {K}_{b o}^{θ} \\ {( {K}_{b o}^{θ} )}^{T} & {K}_{o o}^{θ}\end{matrix} ]}^{- 1} \{ \begin{matrix}{r}_{b}^{θ , ( i )} \\ {r}_{o}^{θ , ( i )}\end{matrix} \} , \qquad ( 33 )$$

Wherein K_{bb}^{θ}, Kₒₒ^{θ} and K_{bo}^{θ} are respectively the coupled stiffness matrices for temperature of the base mesh, the overlay mesh and the two-level mesh, and the expressions are as follows,

$${K}_{b b}^{θ} = - \frac{\partial {r}_{b}^{θ ,}}{\partial {a}_{b}^{( i )}} = {\int }_{{Ω}_{b}} {( {B}_{b}^{θ} )}^{T} {k}_{d} {B}_{b}^{θ} dV + {\int }_{{Ω}_{b}} \frac{ρ {c ( {N}_{b}^{θ} )}^{T} {N}_{b}^{θ}}{Δ t} dV , \qquad ( 34 )$$

$${K}_{o o}^{θ} = - \frac{\partial {r}_{o}^{θ ,}}{\partial {a}_{o}^{( i )}} = {\int }_{{Ω}_{o}} {( {B}_{o}^{θ} )}^{T} {k}_{d} {B}_{o}^{θ} dV + {\int }_{{Ω}_{o}} \frac{ρ {c ( {N}_{o}^{θ} )}^{T} {N}_{o}^{θ}}{Δ t} dV , \qquad ( 35 )$$

$${K}_{b o}^{θ} = - \frac{\partial {r}_{b}^{θ ,}}{\partial {a}_{o}^{( i )}} = {\int }_{{Ω}_{b}} {( {B}_{b}^{θ} )}^{T} {k}_{d} {B}_{o}^{θ} dV + {\int }_{{Ω}_{b}} \frac{ρ {c ( {N}_{b}^{θ} )}^{T} {N}_{o}^{θ}}{Δ t} dV , \qquad ( 36 )$$

Wherein the inherent thermal conductivity k_{d}=k_{d}(ā⁽ⁱ⁻¹⁾) is degraded due to material damage;

Next, fixing the temperature field a⁽ⁱ⁾ of the current iteration step and the phase field ā⁽ⁱ⁻¹⁾ of the previous iteration step, and solving the displacement field â⁽ⁱ⁾ of the current iteration step according to equation (25),

$$\{ \begin{matrix}{\hat{a}}_{b}^{( i )} \\ {\hat{a}}_{b}^{( i )}\end{matrix} \} = \{ \begin{matrix}{\hat{a}}_{b}^{( i - 1 )} \\ {\hat{a}}_{o}^{( i - 1 )}\end{matrix} \} + {[ \begin{matrix}{K}_{b b}^{u} & {K}_{b o}^{u} \\ {( {K}_{b o}^{u} )}^{T} & {K}_{o o}^{u}\end{matrix} ]}^{- 1} \{ \begin{matrix}{r}_{b}^{u , ( i )} \\ {r}_{o}^{u , ( i )}\end{matrix} \} , {K}_{b b}^{u} = - \frac{\partial {r}_{b}^{u , ( i )}}{\partial {\hat{a}}_{b}^{( i )}} = {\int }_{{Ω}_{b}} {( {B}_{b}^{u} )}^{T} {DB}_{b}^{u} dV , \qquad ( 37 )$$

$${K}_{b b}^{u} = - \frac{\partial {r}_{b}^{u , ( i )}}{\partial {\hat{a}}_{b}^{( i )}} = {\int }_{{Ω}_{b}} {( {B}_{b}^{u} )}^{T} {DB}_{b}^{u} dV , \qquad ( 38 )$$

Wherein the elasticity matrix

$$D = \frac{\partial σ}{\partial ε} ,$$

and the expressions of the stiffness matrices Kₒₒ^{u} and K_{bo}^{u} are similar to that of K_{bb}^{u}; it is worth noting that when method III is used to treat the pre-existing cracks, the elasticity matrix near the crack band is weakened, i.e. D*=βD;

Finally, fixing the temperature field a⁽ⁱ⁾ and the displacement field â⁽ⁱ⁾ of the current iteration step, and solving the phase field ā⁽ⁱ⁾ according to equation (26),

$$\{ \begin{matrix}{\overline{a}}_{b}^{( i )} \\ {\overline{a}}_{o}^{( i )}\end{matrix} \} = \{ \begin{matrix}{\overline{a}}_{b}^{( i - 1 )} \\ {\overline{a}}_{o}^{( i - 1 )}\end{matrix} \} + {[ \begin{matrix}{K}_{b b}^{d} & {K}_{b o}^{d} \\ {( {K}_{b o}^{d} )}^{T} & {K}_{o o}^{d}\end{matrix} ]}^{- 1} \{ \begin{matrix}{r}_{b}^{d , ( i )} \\ {r}_{o}^{d , ( i )}\end{matrix} \} , \qquad ( 39 )$$

$$( 40 )$$

$${K}_{b b}^{d} = {\int }_{{Ω}_{b}} \{ {w}^{″} ( d ) {( {N}_{b}^{d} )}^{T} {N}_{b}^{d} H + \frac{{G}_{c}}{{l}_{0}} {( {N}_{b}^{d} )}^{T} {N}_{b}^{d} + {G}_{c} {{l}_{0} ( {B}_{b}^{d} )}^{T} {B}_{b}^{d} \} dV ,$$

Wherein the expressions of the stiffness matrices K_{bo}^{d} and Kₒₒ^{d} are similar to that of K_{bb}^{d};

It should be noted that when method II is used to treat the influence of the pre-existing cracks, the constraint is Gā=0, and the constraint equation is considered into the phase field solution format (39) by the penalty method, that is

$${\overline{a}}^{( i )} = {\overline{a}}^{( i - 1 )} + {[ {K}^{d , ( i )} + α {G}^{T} G ]}^{- 1} {r}^{d , ( i )} . \qquad ( 41 )$$

In combination with FIG. 3, the specific implementation process of the adaptive multi-level phase-field method (AMLPFM) for brittle fracture of elastic materials under thermal shock proposed by the present invention will be shown in the following pseudo-code form:
1). Defining parameters (density ρ, Young's modulus E, Poisson's ratio ν, inherent thermal conductivity k₀, specific heat capacity c, critical energy release rate G_{c}), length scale l₀, time increment Δt, penalty factor α, weakening factor β and so on;
2). Discretizing the finite element model of the multi-level hp mesh, selecting an appropriate method (dividing the geometric model, applying the phase-field Dirichlet boundary condition weakly or weakening the material properties) according to the position of the pre-existing cracks, and initializing the phase field value distribution;
3). Judging the activation states of mesh topological components according to the discrete finite element model;
4). Cycling the time steps l=0, 1, 2, . . . , Nₐ;
   4.1). Initializing the iteration variables i=0, with a⁽ⁱ⁾←a₍ₗ₎, â⁽ⁱ⁾←â₍ₗ₎ and ā⁽ⁱ⁾←ā₍ₗ₎;
   4.2). Starting iterative solution;
      4.2.1). i←i+1;
      4.2.2). Fixing the displacement field â⁽ⁱ⁾ and the phase field ā⁽ⁱ⁻¹⁾ according to equation (33), and updating the temperature field a⁽ⁱ⁾←(a_{b}⁽ⁱ⁾, aₒ⁽ⁱ⁾;
      4.2.3). Fixing the temperature field a⁽ⁱ⁾ and the phase field ā⁽ⁱ⁻¹⁾ according to equation (37), and updating the displacement field â⁽ⁱ⁾←(â_{b}⁽ⁱ⁾, âₒ⁽ⁱ⁾;
      4.2.4). Fixing the temperature field a⁽ⁱ⁾ and the displacement field â⁽ⁱ⁾ according to equation (39) (if equation (41) is used to treat the pre-existing cracks, then according to equation (41)), and updating the phase field ā⁽ⁱ⁾←(ā_{b}⁽ⁱ⁾, āₒ⁽ⁱ⁾);
      4.2.5). If ∥â⁽ⁱ⁾−â⁽ⁱ⁻¹⁾∥/∥â⁽ⁱ⁾−â⁽⁰⁾∥<ϵ and ∥ā⁽ⁱ⁾−ā⁽ⁱ⁻¹⁾∥/∥ā⁽ⁱ⁾−ā⁽⁰⁾∥<ϵ, entering step 4.3); otherwise, returning to step 4.2) to continue iteration;
   4.3). Updating the temperature, displacement and phase fields (a₍ₗ₊₁₎, â₍ₗ₊₁₎, ā₍ₗ₊₁₎)←(a⁽ⁱ⁾, â⁽ⁱ⁾, ā⁽ⁱ⁾);
   4.4). Outputting a calculation document of the current time step, and conducting post-treatment;
5). Returning to step 4) until the calculation is completed;
   In the above implementation steps, ϵ is the convergence tolerance, and ϵ=1×10⁻⁵.

The present invention has the following beneficial effects:

(1) The adaptive multi-level phase-field method for brittle fracture of elastic materials under thermal shock provided by the present invention provides a simple and efficient numerical simulation method for thermal shock fracture analysis, and broadens the application range of the multi-level hp-FEM in the field of fracture analysis. By using the phase field model, the shortcoming that it is difficult to accurately capture crack propagation path using a traditional continuum model can be effectively overcome, and the complex crack propagation problems such as crack intersection, bifurcation and free crack propagation in three-dimensional space can be easily treated. In addition, the present invention can further extend the constitutive model of a material to the fracture analysis of other materials, such as massive deformation fracture analysis, plastic material fracture analysis, etc.;

(2) The efficient adaptive multi-level phase-field method for brittle fracture of elastic materials under thermal shock provided by the present invention uses the multi-level hp-FEM as the adaptive strategy, which can reduce the computing resources and improve the computational efficiency. Compared with the previous adaptive methods, the multi-level hp-FEM realizes local refinement through superimposed meshes, so that no hanging node exists, and the numerical implementation is simple. At the same time, the method fully utilizes the advantages of h-refinement and p-refinement, and can effectively capture high gradients, which is suitable for fracture simulation analysis. In addition, the novel adaptive strategy can also be extended to other large-scale mechanical problems, such as numerical analysis for complex structures, topological optimization, aerodynamic research, etc.;

(3) The efficient adaptive multi-level phase-field method for brittle fracture of elastic materials under thermal shock provided by the present invention develops three multi-level crack treatment techniques under the multi-level framework. In method II, the pre-existing cracks are used as the boundary conditions, and the solution format is corrected by the penalty method, so as to apply the boundary conditions weakly; In method III, the material properties surrounding the pre-existing cracks are weakened to achieve an effect similar to that of method I, the essence of which is to treat the cracks as a fictitious domain. Method III can be further extended to the fictitious domain embedding technology of complex geometric bodies to conduct efficient numerical simulation for complex structures such as lattices and heat sinks;

(4) The efficient adaptive multi-level phase-field method for brittle fracture of elastic materials under thermal shock provided by the present invention uses the Newton-Raphson iteration method to alternately solve the temperature, displacement and phase fields, which greatly reduces the difficulty of numerical implementation, improves the calculation efficiency, and provides a feasible scheme for the parallel computing study of large-scale complex fracture problems.

### DESCRIPTION OF DRAWINGS

FIG. 1 is a schematic diagram of a thermo-mechanical fracture problem of an arbitrary solid domain Ω containing a sharp crack interface Γ and a smeared crack of the present invention, wherein (a) is a sharp crack, and (b) is a smeared crack;

FIG. 2 is a schematic diagram of a multi-level hp-FEM of the present invention, wherein (a) is a one-dimensional schematic diagram, and (b) is a two-dimensional schematic diagram;

FIG. 3 is an efficient adaptive multi-level phase-field method (AMLPFM) for brittle fracture of elastic materials under thermal shock of the present invention;

FIG. 4 is a multi-level schematic diagram of two types of pre-existing cracks of the present invention;

FIG. 5 shows distribution of normal and weakened integration points in pre-existing crack treatment method III of the present invention;

FIG. 6 is a schematic diagram of geometry and boundary conditions for the double edges notched tension test in embodiment 1 of the present invention;

FIG. 7 is a phase field evolution cloud map of pre-existing cracks treated by method II and method III in embodiment 1 of the present invention, wherein (a) is method II and (b) is method III;

FIG. 8 is a comparison diagram of load-displacement curves of pre-existing cracks treated by method II and method III in embodiment 1 of the present invention;

FIG. 9 shows a phase field evolution cloud map and an experimental result diagram of ceramic plate quenching fracture under thermal shock in embodiment 2 of the present invention, wherein (a) is t=0.5 ms, (b) is t=5 ms, (c) is t=30 ms, (d) is t=75 ms, (e) is t=200 ms, and (f) an experimental result.

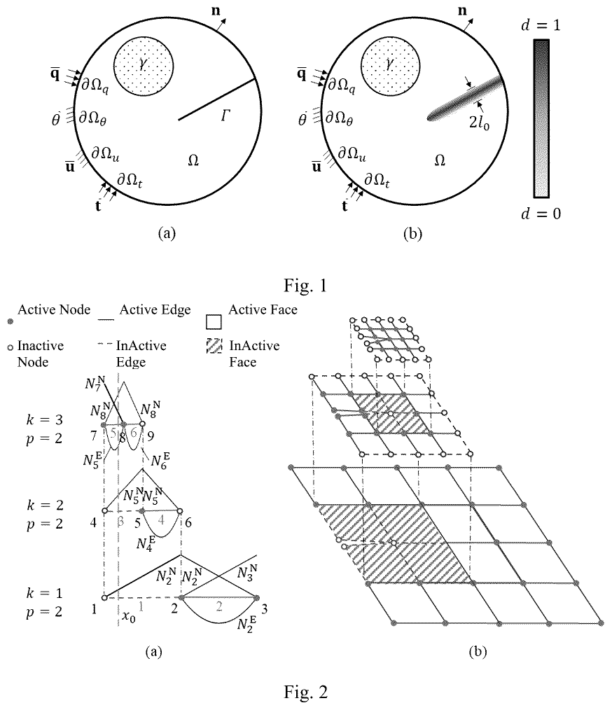

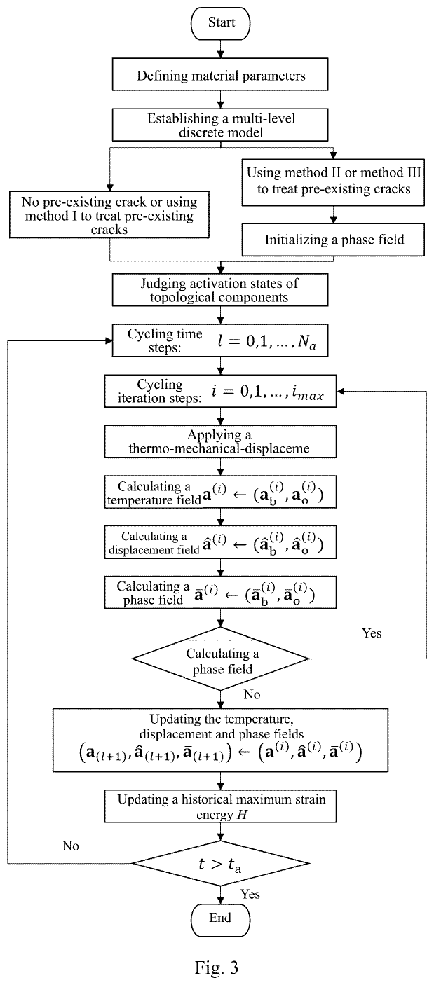

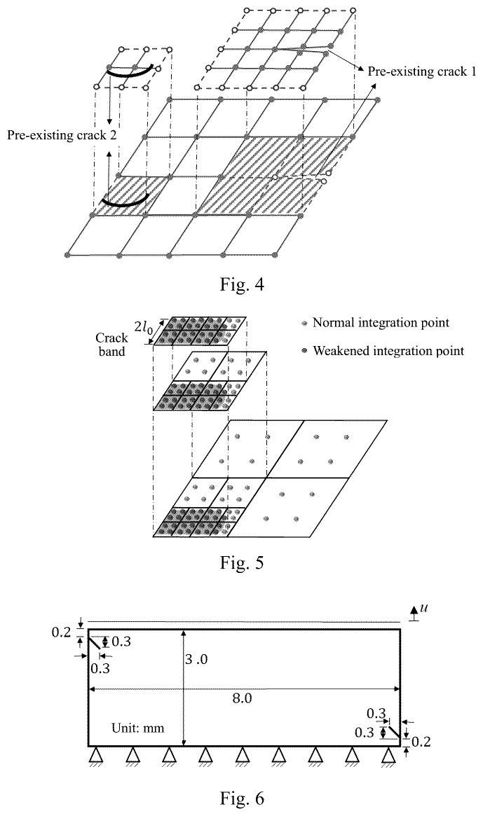

### DETAILED DESCRIPTION

Specific embodiments of the present invention will be further described below in combination with the drawings and the technical solution.

### EMBODIMENTS

The accuracy, reliability and excellent performance of the efficient adaptive multi-level phase-field method (AMLPFM) for brittle fracture of elastic materials under thermal shock proposed by the present invention are further described in detail in combination with FIGS. 6-9.

First, quasi-static tensile brittle fracture simulation of a square plate with inclined initial cracks will be performed to demonstrate the reliability of the developed pre-existing crack treatment techniques and the effectiveness and high efficiency of the adaptive phase-field method for solving fracture problems; then ceramic plate quenching thermal cracking is simulated, the crack path is compared with the experimental results to verify the accuracy of AMLPFM in simulating the fracture behavior under thermal shock. The reference solution in the first embodiment is derived from the work of Kim et al., and the experimental results in the second embodiment are derived from the work of Jiang et al. In all embodiments, quadrilateral elements are used, and the phase field model parameter l₀ is set to be greater than or equal to half of the mesh size hₑ/2 to satisfy the rationality of the numerical simulation results of phase-field fracture. All embodiments are considered as plane strain cases, and the gravity effect is not considered.

### 1) Embodiment 1: Double Edges Notched Tension Test (FIGS. 6-8)

In embodiment 1, the double edges notched tension test as shown in FIG. 6 is simulated, the meshes are refined into 3 levels at the cracks, and the pre-existing cracks are treated by method II (weakly applied phase field boundary conditions) and method III (weakened material properties at the crack), respectively. The lower boundary of the geometric body is fixed, and a vertical displacement load is applied to the upper boundary. The material parameters are shown in Table 1 below.

TABLE 1
Material parameters for double edges notched tension test

| Parameter | E(GPa) | v | l₀(mm) | G_{c}(kN/mm) |
|---|---|---|---|---|
| Value | 210 | 0.3 | 0.015 | 0.0027 |

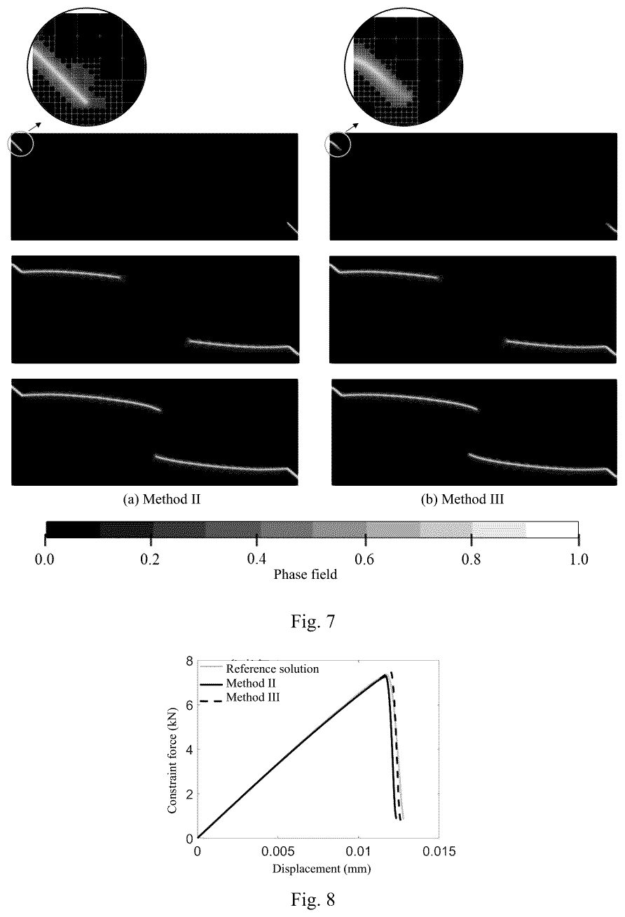

FIG. 7 shows a phase field evolution cloud map of the pre-existing cracks treated by method II and method III. In method II, the phase field value at the pre-existing cracks is ensured to be d=1 before the displacement load is applied, so that the material at the cracks does not have any bearing capacity; in method III, the phase field value is not initialized, and the phase field value at the pre-existing cracks changes gradually from 0 to 1 with the application of the displacement load. Consistent crack propagation paths are obtained by both of the two methods, and crack tips are tracked in the simulation process to dynamically updated the meshes, thus to further reduce the number of degree of freedoms, which makes AMLPFM has a great potential to solve large-scale complex fracture problems. FIG. 8 shows the load-displacement curves of the two methods, and takes the work of Kim et al. as the reference solution. It can be seen that the three curves basically coincide, so that the reliability of the results thereof is verified. In summary, embodiment 1 proves the effectiveness and high efficiency of the adaptive phase-field method proposed by the present invention and the accuracy of the three pre-existing crack treatment techniques.

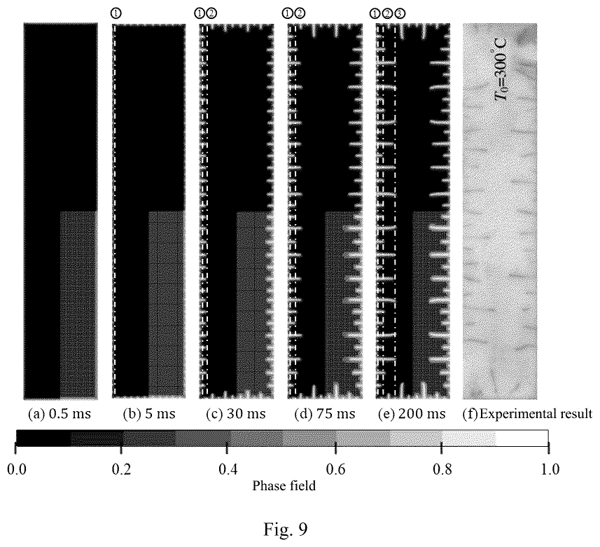

### (2) Embodiment 2: Simulation of Ceramic Plate Quenching Fracture Under Thermal Shock (FIG. 9)

In embodiment 2, ceramic plate quenching fracture under thermal shock is simulated and compared with the experimental results. After a ceramic plate is heated to 300° C. and thrown into a pool of 20° C., the sharp cooling of the ceramic plate leads to crack initiation and propagation. After the ceramic plate is fished out and colored with ink, an internal crack propagation pattern can be observed, as shown in FIG. 9(f). Considering the symmetry of the geometric body, only a quarter model is used here for numerical simulation, and the material parameters thereof are shown in Table 2 below.

TABLE 2
Material parameters of ceramic
plate quenching fracture under thermal shock

| | | | G_{c} | ρ | k₀ | | |
|---|---|---|---|---|---|---|---|
| Para- | E | | (kN/ | (kg/ | (W/ | c | α |
| meter | (GPa) | ν | mm) | m³) | m · K) | (J/(kg · K) | (—) |
| Value | 370 | 0.3 | 42.47 | 3980 | 31 | 880 | 7.5 × 10⁻⁶ |

FIG. 9 shows an evolution cloud map of ceramic plate quenching fracture and the comparison with the experimental results. It can be seen that the meshes are refined dynamically and adaptively with crack propagation, and numerous cracks are produced in the ceramic plate, which are similar to the experimental results, thus it is verified that AMLPFM proposed in the present invention can carry out an efficient and effective numerical simulation study on the fracture behavior of an elastic-brittle material under thermal shock. As shown in FIG. 9(a), at the beginning of the simulation, a consistent damage band is produced on the outer boundary of the ceramic plate, and no crack initiates. Then in FIG. 9(b), small cracks \textcircled{1} of equal length initiate rapidly at equal spacing on the boundary. Subsequently, as shown in FIG. 9(c), about half of the small cracks \textcircled{1} continue to propagate inward to cracks \textcircled{2}, and the other half of the cracks \textcircled{1} stop propagating due to insufficient supply of strain energy. The phenomenon occurs again in FIG. 9(d), and the simulation stops after the small cracks propagate to the cracks \textcircled{3}. The final crack paths are shown in FIG. 9(e), and the results are similar to the experimental results. The fracture process is extremely short, so that it is difficult to observe the crack evolution process through experiments, but the crack propagation process under thermal shock can be more easily and deeply explored by the numerical simulation, which further demonstrates the practicability of AMLPFM of the present invention and has certain scientific and engineering practical significance.

In summary, the above two embodiments verify in detail the accuracy and effectiveness of AMLPFM proposed by the present invention from different levels, respectively, and show the significant advantages of the method in terms of computational efficiency and computational scale, proving the necessity of the present invention. At the same time, the multi-level hp-FEM is used as an adaptive strategy, and the meshes are dynamically refined with crack propagation. Compared with other adaptive strategies, the present invention has no hanging nodes, but has simple numerical implementation, and can also be used in other numerical simulations with high gradients. Therefore, the efficient adaptive multi-level phase-field method (AMLPFM) for brittle fracture of elastic materials under thermal shock proposed by the present invention is a high performance numerical method with a great development prospect.

Embodiments of the present invention are given for example and description purposes, but are not exhaustive or used to limit the present invention to the disclosed forms. Many modifications and changes are apparent to those skilled in the art. The purpose of selecting and describing the embodiments is to preferably illustrate the principles and practical applications of the present invention, so that those skilled in the art can understand the present invention, thereby designing various modified embodiments applied to specific uses.

1. An adaptive multi-level phase-field method for brittle fracture of elastic materials under thermal shock, comprising the following steps:
considering an arbitrary thermo-mechanical solid domain (computational domain) Ω, containing a sharp crack Γ in time t∈[0, tₐ]; combining with the existing thermo-mechanical phase-field fracture model, the following governing equations is obtained,
$$\begin{matrix}∇ \cdot σ + b = 0 , & in Ω \times [ 0 , {t}_{a} ] , & ( 1 ) \\ ρ c \dot{θ} + ∇ \cdot J = γ , & in Ω \times [ 0 , {t}_{a} ] , & ( 2 ) \\ - 2 ( 1 - d ) {ψ}_{e}^{+} + \frac{{G}_{c}}{{l}_{0}} ( d - {l}_{0}^{2} Δ d ) = 0 , & in Ω \times [ 0 , {t}_{a} ] , & ( 3 ) \\ σ \cdot n = \overline{t} , & on \partial {Ω}_{t} \times [ 0 , {t}_{a} ] , & ( 4 ) \\ J \cdot n = \overline{q} , & on \partial {Ω}_{q} \times [ 0 , {t}_{a} ] , & ( 5 ) \\ ∇ d \cdot n = 0 , & on \partial Ω \times [ 0 , {t}_{a} ] , & ( 6 )\end{matrix}$$
wherein equations (1), (2) and (3) are the governing equations of a displacement field u=Ω×[0, tₐ], a temperature field θ=Ω×[0, tₐ] and a phase field d=Ω×[0, tₐ]→[0,1], respectively, and equations (4)-(6) are the corresponding boundary conditions; σ is the Cauchy stress and is the strain energy density of a tensile part, ρ is the density, c is the specific heat capacity, \dot{θ} is the rate at which temperature changes over time, γ is the internal thermal source, G_{c} is the critical energy release rate, lₒ is the crack width used for controlling the width of a smeared crack band, b is the physical strength, J is the heat flux, and n is the outward normal vector of the solid domain boundary ∂Ω; displacement, traction, temperature and heat flux boundary conditions are ∂Ωᵤ, ∂Ωₜ, ∂Ω_{θ} and ∂Ω_{q}, respectively, and displacement ū, traction t̅, temperature θ̅ and heat flux q̅ are applied accordingly;
according to the given strain spectrum decomposition format, decomposing energy density ψₑ into the tensile part ψₑ⁺ and a compressive part ψₑ⁻, and weakening the tensile part, that is,
$${ψ}_{e} ( {ε}_{e} ( u , θ ) ) = w ( d ) {ψ}_{e}^{+} + {ψ}_{\overline{e}} \qquad ( 7 )$$
wherein εₑ is the elastic strain, w(d)=(1−d)²+ξ is the degradation function, 0<ξ<<1 is added to obtain a better numerical stability;
then the Cauchy stress σ can be derived as follows,
$$σ = w ( d ) \frac{\partial {ψ}_{e}^{+}}{\partial {ε}_{e}} + \frac{\partial {ψ}_{\overline{e}}}{\partial {ε}_{e}} \qquad ( 8 )$$
the relationship between the elastic strain εₑ and the thermal strain ε_{θ} under the thermo-mechanical framework is as follows,
$${ε}_{e} = ε - {ε}_{θ} \qquad ( 9 )$$
wherein the total strain under the assumption of small strain is
$$ε = \frac{1}{2} ( ∇ u + {∇}^{T} u ) ,$$
ε_{θ}=α(θ−θ₀)I is the expression of the thermal strain, α is the thermal expansion coefficient, θ₀ is the initial temperature, and I is the identity tensor;
in order to satisfy the irreversibility of crack growth, a historical maximum strain energy H is introduced to replace ψₑ⁺ in formula (3),
$$H = {max}_{τ ∈ [ 0 , t ]} \{ {ψ}_{e}^{+} ( {ε}_{e} , τ ) \} \qquad ( 10 )$$
thus to prevent non-physical crack healing due to the drop of ψₑ⁺;
according to Fourier's law, the heat flux J is,
$$J = - {k}_{d} \cdot ∇ θ \qquad ( 11 )$$
wherein, in order to ensure no heat flux across the crack surface, the inherent thermal conductivity k_{d} is also degraded by the phase field value d, that is,
$${k}_{d} = w ( d ) {k}_{0} \qquad ( 12 )$$
wherein, k₀ is the inherent thermal conductivity for undamaged material; when d=0, the heat transfer capacity of material is not affected, and when d=1, the material no longer has heat transfer capacity;
a novel adaptive strategy is used to solve the thermo-mechanical phase-field fracture model specifically as follows:
the idea of superposition is adopted to realize adaptive refinement, the computational domain Ω is discretized into a base mesh by a coarse mesh, and is locally discretized into a multi-level fine mesh (which is called an overlay mesh) at a crack path; according to the idea of superposition, the approximate physical value at arbitrary x₀ is expressed as follows,
$$u = {u}_{b} + {u}_{o 2} + … + {u}_{o {n}_{k}} \qquad ( 13 )$$
wherein the subscripts b and o represent the base mesh and the overlay mesh, respectively, and u_{b}, uₒ₂ and uₒₙ_{ₖ} represent the approximate physical values on the base mesh and the overlay mesh, respectively;
the adaptive refinement strategy with the idea of superposition is introduced into the governing equations (1)-(6) of the thermo-mechanical phase-field fracture model, and the global computational domain Ω is discretized into the base mesh Ω_{b} and the multi-level overlay mesh Ωₒₙ, wherein n=2, . . . , nₖ; the temperature field θ, the displacement field u, the phase field d and spatial derivatives thereof are expressed as follows,
$$\begin{matrix}θ = {θ}_{b} + {\sum }_{n = 2}^{{n}_{k}} {θ}_{o n} , & u = {u}_{b} + {\sum }_{n = 2}^{{n}_{k}} {u}_{o n} , & d = {d}_{b} + {\sum }_{n = 2}^{{n}_{k}} {d}_{o n} ,\end{matrix} \qquad ( 14 )$$
$$\begin{matrix}∇ θ = ∇ {θ}_{b} + {\sum }_{n = 2}^{{n}_{k}} ∇ {θ}_{o n} , & ε = {ε}_{b} + {\sum }_{n = 2}^{{n}_{k}} {ε}_{on} , & ∇ d = ∇ {d}_{b} + {\sum }_{n = 2}^{{n}_{k}} ∇ {d}_{o n}\end{matrix} \qquad ( 15 )$$
the temperature approximate values θ_{b} and θₒₙ in each level of mesh after discretization can be interpolated as follows,
$$\{ \begin{matrix}{θ}_{b} = {N}_{b}^{N} ( {η}_{b} ) {θ}_{b}^{N} + {N}_{b}^{E} ( {η}_{b} ) {θ}_{b}^{E} + {N}_{b}^{F} ( {η}_{b} ) {θ}_{b}^{F} \\ {θ}_{o n} = {N}_{o n}^{N} ( {η}_{o n} ) {θ}_{o n}^{N} + {N}_{o n}^{E} ( {η}_{o n} ) {θ}_{o n}^{E} + {N}_{o n}^{F} ( {η}_{o n} ) {θ}_{o n}^{F}\end{matrix} \qquad ( 16 )$$
wherein η. is the local coordinates under each level of mesh, N.^{N}, N.^{E} and N.^{F} are the shape functions attached to points, lines and surfaces, and the corresponding temperature values to be obtained on the shape functions are θ.^{N}, θ.^{E} and θ.^{F}; a consistent interpolation format is used for the displacement values u_{b} and uₒₙ and the phase field values d_{b} and dₒₙ;
considering arbitrary virtual variables δθ_{b}, δu_{b}, δd_{b}, δθₒₙ, δuₒₙ and δdₒₙ, the following weak forms are obtained from the governing equations (1)-(6),
$$\{ \begin{matrix}{\int }_{Ω} [ ( ρ c \dot{θ} {δθ}_{b} - J \cdot ∇ {δθ}_{b} ) + {\sum }_{n = 2}^{{n}_{k}} ( ρ c \dot{θ} {δθ}_{o n} - J \cdot ∇ {δθ}_{o n} ) ] dV = δ {F}^{θ} , \\ {\int }_{Ω} ( σ : ∇ δ {u}_{b} + {\sum }_{n = 2}^{{n}_{k}} σ : ∇ δ {u}_{o n} ) dV = δ {F}^{u} , \\ {\int }_{Ω} [ - 2 ( 1 - d ) H δ {d}_{b} + \frac{{G}_{c}}{{l}_{0}} ( {l}_{0}^{2} ∇ d \cdot ∇ δ {d}_{b} ) + d δ {d}_{b} ] d V + \\ {\sum }_{n = 2}^{{n}_{k}} {\int }_{Ω} [ - 2 ( 1 - d ) H δ {d}_{o n} + \frac{{G}_{c}}{{l}_{0}} ( {l}_{0}^{2} ∇ d \cdot ∇ δ {d}_{o n} ) + d δ {d}_{o n} ] d V = 0 ,\end{matrix} \qquad ( 17 )$$
wherein the virtual forces of the temperature field and the displacement field are as follows,
$$δ {F}^{θ} = {\int }_{Ω} ( {γδθ}_{b} + {\sum }_{n = 2}^{{n}_{k}} {γδθ}_{o n} ) d V + {\int }_{\partial Ω} ( \overline{q} \cdot {δθ}_{b} + {\sum }_{n = 2}^{{n}_{k}} \overline{q} \cdot {δθ}_{o n} ) dS , \qquad ( 18 )$$
$$δ {F}^{u} = {\int }_{Ω} ( f \cdot δ {u}_{b} + {\sum }_{n = 2}^{{n}_{k}} f \cdot δ {u}_{o n} ) d V + {\int }_{\partial Ω} ( \overline{t} \cdot δ {u}_{b} + {\sum }_{n = 2}^{{n}_{k}} \overline{t} \cdot δ {u}_{o n} ) d S \qquad ( 19 )$$
the basic format of coupled temperature-displacement-phase field in a multi-level hp mesh is derived based on the above theory and is loaded slowly in a quasi-static state, and then the Newton-Raphson alternating solution strategy is used to simulate crack initiation and propagation, so that the proposed adaptive multi-level phase-field method for brittle fracture of elastic materials under thermal shock is realized.

2. The adaptive multi-level phase-field method for brittle fracture of elastic materials under thermal shock according to claim 1, wherein the adaptive multi-level phase-field method for brittle fracture of elastic materials under thermal shock is realized by MATLAB software programming, and the visualization of the results is realized by ParaView software; the specific steps are as follows:
step 1: establishing a multi-level discrete mesh model and a finite element interpolation format, defining material parameters, considering linear independence and compatibility of shape functions, and judging the activation states of topological components (i.e. points, lines and surfaces) in each level of mesh;
step 2: initializing the phase field values by dividing the geometric model, applying the phase-field Dirichlet boundary condition weakly or weakening the material properties surrounding the pre-existing cracks according to the position of the pre-existing cracks;
step 3: using the Newton-Raphson iteration method to implement the alternating solution strategy in the current time step, updating the temperature, displacement and phase fields successively, and obtaining the temperature value, the displacement value and the phase field value in the current time step when iteration converges;
step 4: storing and outputting the information of relevant variables, returning to step 3, and proceeding to a next time step until the calculation is completed.

3. The adaptive multi-level phase-field method for brittle fracture of elastic materials under thermal shock according to claim 2, wherein,
in step 1, quadrilateral elements are used for discretization and refined into multi-level meshes on the tips or paths of the pre-existing cracks; the symbol m is used to represent the base mesh b and the overlay mesh o; then the temperature field θₘ, the displacement field uₘ and the phase field dₘ of each level of mesh after discretization are expressed as follows,
$$\{ \begin{matrix}{θ}_{m} = {\sum }_{A} {N}_{m A}^{θ} ( x ) {θ}_{m A} = {N}_{m}^{θ} {a}_{m} , \\ {u}_{m} = {\sum }_{A} {N}_{m A}^{u} ( x ) {u}_{m A} = {N}_{m}^{u} {\hat{a}}_{m} , \\ {d}_{m} = {\sum }_{A} {N}_{m A}^{d} ( x ) {d}_{m A} = {N}_{m}^{d} {\overline{a}}_{m}\end{matrix} \qquad ( 20 )$$
wherein N_{mA}^{θ}(x), N_{mA}^{u}(x) and N_{mA}^{d}(x) are the shape functions of the temperature, displacement and phase fields of the corresponding topological components; Nₘ^{θ}, Nₘ^{u} and Nₘ^{d} are the shape function matrices of the three fields, respectively, and the temperature value θ_{mA}, the displacement value u_{mA} and the phase field value d_{mA} attached to the topological components are assembled as vectors aₘ, \hat{d}ₘ and āₘ, respectively;
then the spatial derivatives of the three fields are further expressed as follows,
$$\{ \begin{matrix}∇ {θ}_{m} = {\sum }_{A} {B}_{m A}^{θ} ( x ) {θ}_{m A} = {B}_{m}^{θ} {a}_{m} , \\ {ε}_{m} = {\sum }_{A} {B}_{m A}^{u} ( x ) {u}_{m A} = {B}_{m}^{u} {\hat{a}}_{m} , \\ ∇ {d}_{m} = {\sum }_{A} {B}_{m A}^{d} ( x ) {d}_{m A} = {B}_{m}^{d} {\overline{a}}_{m}\end{matrix} \qquad ( 21 )$$
wherein B_{mA}^{θ}, B_{mA}^{u} and B_{mA}^{d} are
$${B}_{m A}^{θ} ( x ) = [ \begin{matrix}{\partial }_{x} {N}_{m A}^{θ} \\ {\partial }_{y} {N}_{m A}^{θ}\end{matrix} ] , {B}_{m A}^{u} ( x ) = [ \begin{matrix}{\partial }_{x} {N}_{m A}^{u} & 0 \\ 0 & {\partial }_{y} {N}_{m A}^{u} \\ {\partial }_{y} {N}_{m A}^{u} & {\partial }_{x} {N}_{m A}^{u}\end{matrix} ] , {B}_{m A}^{d} ( x ) = [ \begin{matrix}{\partial }_{x} {N}_{m A}^{d} \\ {\partial }_{y} {N}_{m A}^{d}\end{matrix} ] \qquad ( 22 )$$
wherein ∂ₓ and ∂_{y} represent the derivatives with respect to the x and y axes, respectively;
considering the above discretization treatment and combining with the weak form (17) to obtain the residual equations of the three fields as follows, respectively,
$$\{ \begin{matrix}{( {δθ}_{b} )}^{T} \cdot {r}_{b}^{θ} + {( {δθ}_{o} )}^{T} \cdot {r}_{o}^{θ} = 0 , \\ {( δ {u}_{b} )}^{T} \cdot {r}_{b}^{u} + {( δ {u}_{o} )}^{T} \cdot {r}_{o}^{u} = 0 , \\ {( δ {d}_{b} )}^{T} \cdot {r}_{b}^{d} + {( δ {d}_{o} )}^{T} \cdot {r}_{o}^{d} = 0\end{matrix} \qquad ( 23 )$$
wherein r_{b}^{θ}, rₒ^{θ}, r_{b}^{u}, rₒ^{u}, r_{b}^{d} and rₒ^{d} are the residuals of the temperature, displacement and phase fields in each level of mesh, and b and o are used as subscripts to replace m, then the expressions of the temperature field residual rₘ^{θ}, the displacement field residual rₘ^{u} and phase field residual rₘ^{d} in each level of mesh are as follows,
$${r}_{m}^{θ} = {( {f}_{m}^{θ} )}_{e x t} - {\int }_{{Ω}_{m}} {( {B}_{m}^{θ} )}^{T} {k}_{d} ∇ θ d V - {\int }_{{Ω}_{m}} ρ {c ( {N}_{m}^{θ} )}^{T} \dot{θ} dV , \qquad ( 24 )$$
$${r}_{m}^{u} = {( {f}_{m}^{u} )}_{e x t} - {\int }_{{Ω}_{m}} {( {B}_{m}^{u} )}^{T} σ dV , \qquad ( 25 )$$
$${r}_{m}^{d} = - [ {\int }_{{Ω}_{m}} \frac{{G}_{c}}{{l}_{0}} {( {N}_{m}^{d} )}^{T} d d V + {\int }_{{Ω}_{m}} {G}_{c} {{l}_{0} ( {B}_{m}^{d} )}^{T} ∇ ddV + {\int }_{{Ω}_{m}} {w}^{′} ( d ) {( {N}_{m}^{d} )}^{T} H d V ] \qquad ( 26 )$$
at the same time, the external force (fₘ^{θ})ₑₓₜ of the temperature field and the external force (fₘ^{u})ₑₓₜ of the displacement field are as follows,
$${( {f}_{m}^{θ} )}_{e x t} = {\int }_{{Ω}_{m}} {( {N}_{m}^{θ} )}^{T} γ d V + {\int }_{\partial {Ω}_{q}} {( {N}_{m}^{θ} )}^{T} \overline{q} dS , \qquad ( 27 )$$
$${( {f}_{m}^{u} )}_{e x t} = {\int }_{{Ω}_{m}} {ρ ( {N}_{m}^{u} )}^{T} b d V + {\int }_{\partial {Ω}_{t}} {( {N}_{m}^{u} )}^{T} \overline{t} dS . \qquad ( 28 )$$

4. The adaptive multi-level phase-field method for brittle fracture of elastic materials under thermal shock according to claim 2, wherein in step 2, the phase field is initialized according to the position of the pre-existing cracks; two types of pre-existing cracks are found, wherein cracks 1 coincide with the edge of an element in each level of mesh, and cracks 2 pass diagonally through the inside of the element; the influence of pre-existing cracks will be considered by three methods:
method I: dividing the geometric model; the pre-existing cracks 1 are only refined locally in a crack tip region, and the mesh along the crack path is not treated, thus the pre-existing cracks 1 is treated by dividing the geometric model; method I is only suitable for the first type of pre-existing cracks;
method II: applying the phase-field Dirichlet boundary condition; the influence of arbitrary cracks can be considered by ensuring the phase field value d=1 at the pre-existing cracks in the simulated process; however, for the pre-existing cracks 2 passing diagonally through the inside of the element, the Dirichlet boundary condition cannot be applied directly to the corresponding topological components to constrain the phase field value in the element; the penalty method is used to apply the phase-field Dirichlet boundary condition weakly to the inside of the element, and the steps are as follows:
first, selecting a number of nodes along the pre-existing cracks and letting the phase field value d=1 at the nodes, then the corresponding constraints are as follows,
$$\begin{matrix}[ \begin{matrix}{G}_{b b} & {G}_{b o} \\ {G}_{o b} & {G}_{o o}\end{matrix} ] \{ \begin{matrix}{\overline{a}}_{b} \\ {\overline{a}}_{o}\end{matrix} \} = V & \to & G \overline{a} = V\end{matrix} \qquad ( 29 )$$
wherein G is the shape function matrix of the selected nodes in the base mesh and the overlay mesh, and V is a vector filled by element 1;
then considering the above constraint equations in a pure phase field diffusion model; the initial phase field distribution is obtained, and the solution format is as follows,
$$( {K}^{d} + α {G}^{T} G ) \overline{a} = α {G}^{T} V \qquad ( 30 )$$
wherein α=1×10⁵ is the penalty factor, and K^{d} is the total stiffness matrix for phase field;
finally, using the Newton-Raphson iteration method make V=0 in the subsequent time steps to ensure that the phase field value on the pre-existing cracks alway maintains that d=1;
method III: weakening the material properties surrounding the pre-existing cracks; for the pre-existing cracks 2, the effect of method I is achieved by weakening the material properties surrounding the pre-existing cracks, which is equivalent to making the material near the crack band particularly soft; here, a minimal scalar β is introduced to weaken the elasticity matrix of the crack band, that is,
$${D}^{*} = β D \qquad ( 31 )$$
wherein 0<<β<1;
both method II and method III can be used for treating various types of pre-existing cracks; in a solution process, method II is to introduce a penalty term to the solution format, while method III does not require additional operations.

5. The adaptive multi-level phase-field method for brittle fracture of elastic materials under thermal shock according to claim 2, wherein in step 3, the Newton-Raphson iteration method is used to implement the alternating solution strategy in the current time step [tₗ, tₗ₊₁], and the temperature, displacement and phase fields are updated successively; wherein \dot{θ} in the residual equation (24) of the temperature field is express as follows by the backward difference method,
$$\dot{θ} = \frac{{θ}_{l + 1} - {θ}_{l}}{Δ t} \qquad ( 32 )$$
wherein Δt=tₗ₊₁−tₗ is the time increment; the coupled nonlinear equations (24)-(26) are solved by the Newton-Raphson iteration method, wherein the solution format of the i^{th} iteration step is as follows:
first, fixing the displacement field â⁽ⁱ⁻¹⁾ and the phase field ā⁽ⁱ⁻¹⁾ of the previous iteration step, and solving the temperature field a⁽ⁱ⁾ of the current iteration step according to equation (24),
$$\{ \begin{matrix}{a}_{b}^{( i )} \\ {a}_{o}^{( i )}\end{matrix} \} = \{ \begin{matrix}{a}_{b}^{( i - 1 )} \\ {a}_{o}^{( i - 1 )}\end{matrix} \} + {[ \begin{matrix}{K}_{b b}^{θ} & {K}_{b o}^{θ} \\ {( {K}_{b o}^{θ} )}^{T} & {K}_{o o}^{θ}\end{matrix} ]}^{- 1} \{ \begin{matrix}{r}_{b}^{θ , ( i )} \\ {r}_{o}^{θ , ( i )}\end{matrix} \} \qquad ( 33 )$$
wherein K_{bb}^{θ}, Kₒₒ^{θ} and K_{bo}^{θ} are respectively the coupled stiffness matrices for temperature of the base mesh, the overlay mesh and the two-level mesh, and the expressions are as follows,
$${K}_{b b}^{θ} = - \frac{\partial {r}_{b}^{θ , ( i )}}{\partial {a}_{b}^{( i )}} = {\int }_{{Ω}_{b}} {( {B}_{b}^{θ} )}^{T} {k}_{d} {B}_{b}^{θ} d V + {\int }_{{Ω}_{b}} \frac{ρ {c ( {N}_{b}^{θ} )}^{T} {N}_{b}^{θ}}{Δ t} dV , \qquad ( 34 )$$
$${K}_{o o}^{θ} = - \frac{\partial {r}_{o}^{θ , ( i )}}{\partial {a}_{o}^{( i )}} = {\int }_{{Ω}_{o}} {( {B}_{o}^{θ} )}^{T} {k}_{d} {B}_{o}^{θ} d V + {\int }_{{Ω}_{o}} \frac{ρ {c ( {N}_{o}^{θ} )}^{T} {N}_{o}^{θ}}{Δ t} dV , \qquad ( 35 )$$
$${K}_{b o}^{θ} = - \frac{\partial {r}_{b}^{θ , ( i )}}{\partial {a}_{o}^{( i )}} = {\int }_{{Ω}_{b}} {( {B}_{b}^{θ} )}^{T} {k}_{d} {B}_{o}^{θ} d V + {\int }_{{Ω}_{b}} \frac{ρ {c ( {N}_{b}^{θ} )}^{T} {N}_{o}^{θ}}{Δ t} d V \qquad ( 36 )$$
wherein the inherent thermal conductivity k_{d}=k_{d}(ā⁽ⁱ⁻¹⁾) is degraded due to material damage;
next, fixing the temperature field a⁽ⁱ⁾ of the current iteration step and the phase field ā⁽ⁱ⁻¹⁾ of the previous iteration step, and solving the displacement field â⁽ⁱ⁾ of the current iteration step according to equation (25),
$$\{ \begin{matrix}{\hat{a}}_{b}^{( i )} \\ {\hat{a}}_{o}^{( i )}\end{matrix} \} = \{ \begin{matrix}{\hat{a}}_{b}^{( i - 1 )} \\ {\hat{a}}_{o}^{( i - 1 )}\end{matrix} \} + {[ \begin{matrix}{K}_{b b}^{u} & {K}_{b o}^{u} \\ {( {K}_{b o}^{u} )}^{T} & {K}_{o o}^{u}\end{matrix} ]}^{- 1} \{ \begin{matrix}{r}_{b}^{u , ( i )} \\ {r}_{o}^{u , ( i )}\end{matrix} \} , \qquad ( 37 )$$
$${K}_{b b}^{u} = - \frac{\partial {r}_{b}^{u , ( i )}}{\partial {\hat{a}}_{b}^{( i )}} = {\int }_{{Ω}_{b}} {( {B}_{b}^{u} )}^{T} D {B}_{b}^{u} d V \qquad ( 38 )$$
wherein the elasticity matrix
$$D = \frac{\partial σ}{\partial ε} ,$$
and the expressions of the stiffness matrices Kₒₒ^{u} and K_{bo}^{u} are similar to that of K_{bb}^{u}; it is worth noting that when method III is used to treat the pre-existing cracks, the elasticity matrix near the crack band is weakened, i.e. D*=βD;
finally, fixing the temperature field a⁽ⁱ⁾ and the displacement field â⁽ⁱ⁾ of the current iteration step, and solving the phase field ā⁽ⁱ⁾ according to equation (26),
$$\{ \begin{matrix}{\overline{a}}_{b}^{( i )} \\ {\overline{a}}_{o}^{( i )}\end{matrix} \} = \{ \begin{matrix}{\overline{a}}_{b}^{( i - 1 )} \\ {\overline{a}}_{o}^{( i - 1 )}\end{matrix} \} + {[ \begin{matrix}{K}_{b b}^{d} & {K}_{b o}^{d} \\ {( {K}_{b o}^{d} )}^{T} & {K}_{o o}^{d}\end{matrix} ]}^{- 1} \{ \begin{matrix}{r}_{b}^{d , ( i )} \\ {r}_{o}^{d , ( i )}\end{matrix} \} , \qquad ( 39 )$$
$${K}_{b b}^{d} = {\int }_{{Ω}_{b}} \{ {w}^{″} ( d ) {( {N}_{b}^{d} )}^{T} {N}_{b}^{d} H + \frac{{G}_{c}}{{l}_{0}} {( {N}_{b}^{d} )}^{T} {N}_{b}^{d} + {G}_{c} {{l}_{0} ( {B}_{b}^{d} )}^{T} {B}_{b}^{d} \} dV \qquad ( 40 )$$
wherein the expressions of the stiffness matrices K_{bo}^{d} and Kₒₒ^{d} are similar to that of K_{bb}^{d};
it should be noted that when method II is used to treat the influence of the pre-existing cracks, the constraint is Gā=0, and the constraint equation is considered into the phase field solution format (39) by the penalty method, that is
$${\overline{a}}^{( i )} = {\overline{a}}^{( i - 1 )} + {[ {K}^{d , ( i )} + α {G}^{T} G ]}^{- 1} {r}^{d , ( i )} \qquad ( 41 )$$

6. The adaptive multi-level phase-field method for brittle fracture of elastic materials under thermal shock according to claim 2, wherein the specific implementation process of the adaptive multi-level phase-field method for brittle fracture of elastic materials under thermal shock will be shown in the following pseudo-code form:
1). defining parameters (density ρ, Young's modulus E, Poisson's ratio ν, inherent thermal conductivity k₀, specific heat capacity c, critical energy release rate G_{c}), length scale l₀, time increment Δt, penalty factor α, weakening factor β and so on;
2). discretizing the finite element model of the multi-level hp mesh, selecting the method of dividing the geometric model, applying the phase-field Dirichlet boundary condition weakly or weakening the material properties according to the position of the pre-existing cracks, and initializing the phase field value distribution;
3). judging the activation states of mesh topological components according to the discrete finite element model;
4). cycling the time steps l=0, 1, 2, . . . , Nₐ;
4.1). initializing the iteration variables i=0, with a⁽ⁱ⁾←a₍ₗ₎, â⁽ⁱ⁾←â₍ₗ₎ and ā⁽ⁱ⁾←ā₍ₗ₎;
4.2). starting iterative solution;
4.2.1). i←i+1;
4.2.2). fixing the displacement field â⁽ⁱ⁾ and the phase field ā⁽ⁱ⁻¹⁾ according to equation (33), and updating the temperature field a⁽ⁱ⁾←(a_{b}⁽ⁱ⁾, aₒ⁽ⁱ⁾;
4.2.3). fixing the temperature field a⁽ⁱ⁾ and the phase field ā⁽ⁱ⁻¹⁾ according to equation (37), and updating the displacement field â⁽ⁱ⁾←(â_{b}⁽ⁱ⁾, âₒ⁽ⁱ⁾;
4.2.4). fixing the temperature field a⁽ⁱ⁾ and the displacement field â⁽ⁱ⁾ according to equation (39) (if equation (41) is used to treat the pre-existing cracks, then according to equation (41)), and updating the phase field ā⁽ⁱ⁾←(ā_{b}⁽ⁱ⁾, āₒ⁽ⁱ⁾);
4.2.5). if ∥â⁽ⁱ⁾−â⁽ⁱ⁻¹⁾∥/∥â⁽ⁱ⁾−â⁽⁰⁾∥<ϵ and ∥ā⁽ⁱ⁾−ā⁽ⁱ⁻¹⁾∥/∥ā⁽ⁱ⁾−ā⁽⁰⁾∥<ϵ, entering step 4.3); otherwise, returning to step 4.2) to continue iteration;
4.3). updating the temperature, displacement and phase fields (a₍ₗ₊₁₎, â₍ₗ₊₁₎, ā₍ₗ₊₁₎)←(a⁽ⁱ⁾, â⁽ⁱ⁾, ā⁽ⁱ⁾);
4.4). outputting a calculation document of the current time step, and conducting post-treatment;
5). returning to step 4) until the calculation is completed;

7. The adaptive multi-level phase-field method for brittle fracture of elastic materials under thermal shock according to claim 6, wherein,
ϵ is the convergence tolerance, and ϵ=1×10⁻⁵.
